(19) United States
(12) Patent Application Publication
(10) Pub. No.: US 2020/0279338 A1
(43) Pub. Date: Sep. 3, 2020

(54) Sandboxx Matching Application

(71) Applicants: Leslie Strong, Toronto (CA); Greg De Koker, Toronto (CA)

(72) Inventors: Leslie Strong, Toronto (CA); Greg De Koker, Toronto (CA)

(21) Appl. No.: 16/804,380

(22) Filed: Feb. 28, 2020

Related U.S. Application Data
(60) Provisional application No. 62/812,306, filed on Mar. 1, 2019.

(51) Int. Cl. G06Q 50/00; G06Q 10/10; G06F 16/9535; G06F 16/906

(52) U.S. Cl. CPC G06Q 50/01; G06F 16/906; G06F 16/9535; G06Q 10/105

(57) ABSTRACT

This disclosure relates to the field of corporate communications and personnel development through a system and method for automatically and optimally matching a mentor and a mentee, taking the diverse backgrounds, levels of experience and personal development goals in optimizing the match.

### CROSS-REFERENCE TO RELATED APPLICATIONS

This application claims priority to co-pending U.S. Provisional patent application Ser. No. 62/812,306 titled “Sandboxx Matching Application”, filed on Mar. 1, 2019 the disclosure of which is herein incorporated by reference in its entirety.

### PATENTS CITED

The following documents and references are incorporated by reference in their entirety, Carrico et al (U.S. Pat. Pub. No. 2009/0164464), Barfield J R et al (U.S. Pat. No. 2015/0341297) and Tian Yong Li (Korea Patent Publication KR20190024857).

### FIELD OF THE INVENTION

This disclosure relates in general to the field of corporate communications and more particularly to a system and a method for automatically and optimally matching a sponsor and sponsoree, while taking diverse backgrounds or experiences in optimizing the match.

### DESCRIPTION OF THE RELATED ART

Engaging high potential employees, and facilitating their personal and professional development within a corporate culture is critical to the long-term development of corporate talent and resources. Significant changes in personal and generational evolution, has resulted in the loss of effectiveness of traditional mentoring programs.

In short, employee engagement has flatlined. The new generations, with no small effect contributed by their much larger and diverse backgrounds, are having a tough time ‘finding’ mentors, and developing the relationships that are required to transition the knowledge from Mentor to Mentored and vice-versa.

To improve engagement, companies must move beyond archaic methods and adopt ones known to have the greatest impact on inspiring human performance in the workplace. In many cases, engagement largely comes down to whether people have a manager who cares about them, supports them and appreciates them. Just like diversity, it really needs to start at the CEO and executive level. Employees need to know that it's a corporate initiative to which every manager and leader in the company is fully accountable.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In one aspect the invention is about a computerized system for matching sponsors and sponsorees within an organization, said system comprising one or more communicatively coupled computer processors, said one or more computer processors forming a computer system configured to perform the steps of: receiving, at said computer system, a request from a sponsor or sponsoree for inclusion in said matching system, collecting information about said sponsor or sponsoree, including name, position, authorization code, address, email and/or telephone number, acquiring one or more answers to a set of questions from a sponsor, acquiring one or more answers to a set of questions from a sponsoree, calculating the Direct Match (DM) and Indirect Match (IM) percentage of each Sponsor (DM_{S}/IM_{S}) match and for each Sponsoree (DM_{E}/IM_{E}) and automatically connecting the top matches to each other. In another aspect, the direct match percentage for Sponsoree (DM_{E}) is calculated as: DM_{E}=(N_{E}/D_{X})*100, and the direct match percentage for Sponsor (DM_{S}) is calculated as: DM_{S}=(N_{S}/D_{X})*100, where N_{S} is the number of answers chosen/provided by the Sponsor, N_{E} is the number of answers chosen/provided by the Sponsoree, D_{S} is the number of answers provided by Sponsor, D_{E} is the number of answers provided by Sponsoree and wherein Dₓ is the same as D_{S} and D_{E} and the indirect match percentage is calculated as, IM_{E}=(N_{E}/D_{X})*100, IM_{S}=(N_{S}/D_{X})*100 for the Sponsoree (IM_{E}) or Sponsor (IM_{S}) and calculated the same as above (for either Sponsor or Sponsoree), but since and D_{S} and D_{E} are not the same, the largest is selected as D_{X}.

In one aspect, the invention is about a method for matching sponsors and sponsorees by a computer system within an organization, said method comprising providing one or more communicatively coupled computer processors, said one or more computer processors forming a computer system configured to perform the steps of: receiving, at said computer system, a request from a sponsor or sponsoree for inclusion in said matching system; collecting information about said sponsor or sponsoree, including name, position, authorization code, address, email and/or telephone number; acquiring one or more answers to a set of questions from a sponsor, acquiring one or more answers to a set of questions from a sponsoree, calculating the Direct Match (DM) and Indirect Match (IM) percentage of each Sponsor (DM_{S}/IM_{S}) match and for each Sponsoree (DM_{E}/IM_{E}) and automatically connecting the top matches to each other. In another aspect, the direct match percentage for Sponsoree (DM_{E}) is calculated as: DM_{E}=(N_{E}/D_{X})*100, and the direct match percentage for Sponsor (DM_{S}) is calculated as: DM_{S}=(N_{S}/D_{X})*100, where N_{S} is the number of answers chosen/provided by the Sponsor, N_{E} is the number of answers chosen/provided by the Sponsoree, D_{S} is the number of answers provided by Sponsor, D_{E} is the number of answers provided by Sponsoree and wherein Dₓ is the same as Ds and D_{E} and the indirect match percentage is calculated as, IM_{E}=(N_{E}/D_{X})*100, IM_{S}=(N_{S}/D_{X})*100 for the Sponsoree (IM_{E}) or Sponsor (IM_{S}) and calculated the same as above (for either Sponsor or Sponsoree), but since and D_{S} and D_{E} are not the same, the largest is selected as D_{X}.

In one aspect the invention is about a non-transitory computer-readable medium embodying a program executable in at least one computing device, the program, when executed, causing the at least one computing device to at least, one or more communicatively coupled computer processors, said one or more computer processors forming a computer system configured to perform the steps of: receiving, at said computer system, a request from a sponsor or sponsoree for inclusion in said matching system, collecting information about said sponsor or sponsoree, including name, position, authorization code, address, email and/or telephone number, acquiring one or more answers to a set of questions from a sponsor, acquiring one or more answers to a set of questions from a sponsoree, calculating the Direct Match (DM) and Indirect Match (IM) percentage of each Sponsor (DM_{S}/IM_{S}) match and for each Sponsoree (DM_{E}/IM_{E}), and automatically connecting the top matches to each other. In another aspect, the direct match percentage for Sponsoree (DM_{E}) is calculated as: DM_{E}=(N_{E}/D_{X})*100, and the direct match percentage for Sponsor (DMs) is calculated as: DM_{S}=(N_{S}/D_{X})*100, where N_{S} is the number of answers chosen/provided by the Sponsor, N_{E} is the number of answers chosen/provided by the Sponsoree, D_{S} is the number of answers provided by Sponsor, D_{E} is the number of answers provided by Sponsoree and wherein Dₓ is the same as D_{S} and D_{E} and the indirect match percentage is calculated as, IM_{E}=(N_{E}/D_{X})*100, IM_{S}=(N_{S}/D_{X})*100 for the Sponsoree (IM_{E}) or Sponsor (IM_{S}) and calculated the same as above (for either Sponsor or Sponsoree), but since and D_{S} and D_{E} are not the same, the largest is selected as D_{X}.

Other features and advantages of the present invention will become apparent upon examining the following detailed description of an embodiment thereof, taken in conjunction with the attached drawings.

### BRIEF DESCRIPTION OF THE DRAWINGS

FIG. 1 shows an illustration of the personal screens of the Sandboxx application, according to an exemplary embodiment of the invention.

FIG. 2 shows an illustration of one of the sponsoree's interaction screens in the Sandboxx application, according to an exemplary embodiment of the invention.

FIG. 3 shows an illustration of one of the sponsor's interaction screens in the Sandboxx application, according to an exemplary embodiment of the invention.

FIG. 4 shows a selection of screen of a Sandboxx application applicant's personal values, according to an exemplary embodiment of the invention.

FIG. 5 shows a selection of screen of a Sandboxx application applicant's personal passions, according to an exemplary embodiment of the invention.

FIG. 6 shows a matching result for various sponsors within the Sandboxx application, according to an exemplary embodiment of the invention.

The above-described and other features will be appreciated and understood by those skilled in the art from the following detailed description, drawings, and appended claims.

### DETAILED DESCRIPTION OF THE PREFERRED EMBODIMENT

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

Simplifications or omissions may be made to avoid obscuring the purpose of the section. Such simplifications or omissions are not intended to limit the scope of the present invention. All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

The process of mentor vis-à-vis mentee, i.e. the person providing advice and guidance (mentor) to a less experienced individual (Mentee) has been well understood. Less well understood is the more advanced process of sponsorship. It's when a senior leader (sponsor) is committed to the development and advancement of a sponsoree. It's also a 2-way, mutually beneficial relationship between the sponsor and sponsoree.

A sponsor is a senior leader who believes in the sponsoree and their potential. A sponsor is someone who: Advocates for their sponsoree's growth and advancement; Uses their reputation capital on behalf of their sponsoree; Expects a great deal from their sponsoree—specifically high performance and loyalty—as this is a 2-way relationship; Encourages their sponsoree to take risks and has their back and Invests in the future of the sponsoree, the organization and themselves.

A sponsor is an experienced person who is willing to help and support their mentee. A sponsor is someone who: May or may not work for the same company as their mentee; Builds their mentee's confidence and provides a sounding board; Offers empathy and an ear to their mentee; Expects very little in return from their mentee—as this is typically a 1-way relationship and Focuses primarily on listening to, as well as, advising the mentee.

Sponsorship is the most effective way to advance anyone in organizations—including high performers, high potential employees, new employees, women, minority groups, other underrepresented groups—anyone. Sponsorship helps employees feel included, valued, respected and empowered. Sponsorship helps to accelerate leadership, advancement and inclusion. As a result, sponsorship drives employee engagement.

Employee engagement, in turn, drives significant business results, such as: Better corporate culture; Higher employee retention; Higher employee attraction; Better customer service; Higher customer loyalty; Higher productivity and Higher profitability.

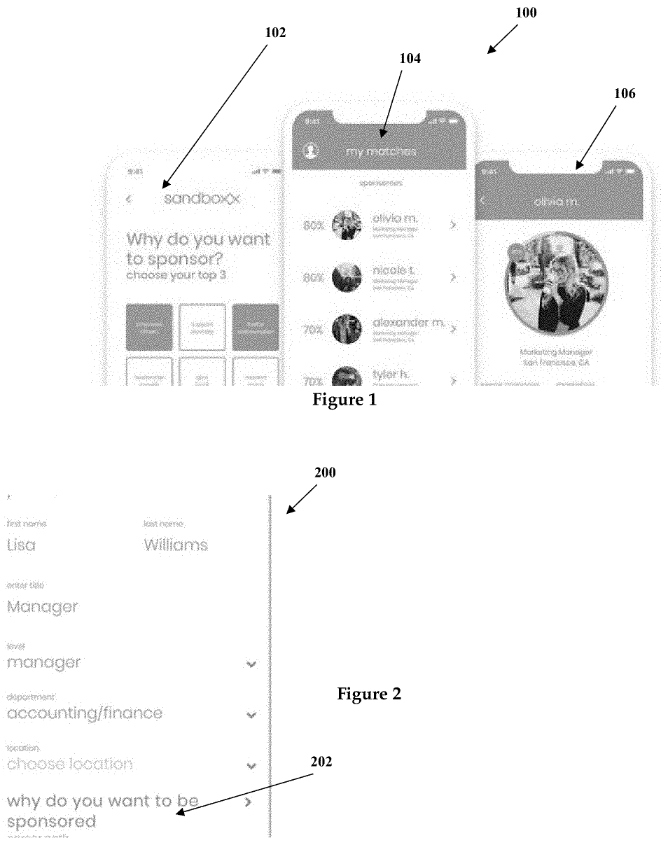

We see in FIG. 1 an overview 100 of the possible sponsor's screens for the Sandboxx application, including a selection of the reasons to become a sponsor 102, potential individuals to sponsor 104 and the profile of a specific potential sponsoree 104.

The Sandboxx system and method can be implemented as a simple-to-use tool (withing a desktop or mobile application), which helps companies accelerate leadership by matching senior leaders with mentees (or sponsorees) using a unique sponsorship technology. Sponsorship is proven to be the most effective way to advance women, high potentials, and under-represented groups while impacting the entire culture and bottom line of the organization.

By managing all aspects of the sponsorship program, Sanboxx allows for sponsor to sponsoree matching, while at the same time allowing Human Resources (HR) to monitor the participants, including proprietary and customizable (based on any organization's unique conditions) matching algorithms to automatically determine the best possible matches for all sponsors and sponsorees (up to 5 suggested matches).

Using custom Push Notification technology, Sandboxx allows for customized notices, reminders and progress questions to be delivered to the mobile device of any and all participants according to any schedule. In-app Feedback feature allows for participants to answer questions on their mobile devices, where data is then collected, collated and reported back to the pilot company for ongoing monitoring. Finally, the Sandboxx App automatically unmatches all participants after a maximum (and programmable) duration period.

The Sandboxx App helps to create inclusive corporate cultures by matching senior leaders (Sponsors) with Sponsoree's to increase employee inclusion, significantly impact employee retention, attraction, and succession, improve the overall employee experience in the company, grow productivity, boost profits and implement a proven method of success to your inclusion and diversity strategy.

Sandboxx does this using a unique feature set which includes: the best possible matches automatically generated through unique profiling questions and matching algorithms, reducing unconscious biases through automatically generated matches, alleviating administrative, logistical and project management overwhelm. In one embodiment, this can be done with a minimum of only 3 to 5 automatically generated suggested matches, everything is faster, simpler and manageable and using Online training resources to drive a successful sponsor/sponsoree relationship after the successful match.

Note when we speak of the Sandboxx App, we describe a computerized process taking place within a processor/memory/display unit, such as a Smartphone/Tablet/PC, that is connected through the Internet (fixed and/or mobile) to one or more computer server(s), so that a computer processing unit capable of taking the various inputs and performing the matches with minimal or no human meddling.

The system is capable of Ongoing Data Reporting, providing both users and overseers (such as HR or other ethic/corporate governance departments or designees) through gauges that display the success of the matches and overall program in real-time. These may include reports on: profiles created and completed, the status of match requests and matches, the status of meetings, successful achievement of objectives, the progress of relationship development of matched participants and final evaluations of the program.

In one embodiment, program materials include all suggested (and customizable) meeting formats, questions, and evaluations to operate a successful sponsorship program, including; First Meeting—after matching, sponsor and sponsoree meet in-person or online to determine objectives and Follow-on Meetings—with program commencement, participants meet monthly either virtually or in-person to review objectives, assess progress and determine next steps. These include: Prior to Final Meeting—participants review the progress of objectives, discuss accomplishments and shortfalls, and complete Evaluation Form and Program Concludes—after 6 months of monthly meetings, participants review Evaluation Forms, provide each other with feedback, and celebrate accomplishments.

The Sandboxx match algorithm works on the concept of matching the answers from both parties (Sponsor/Sponsoree) to related questions. FIG. 2 illustrates a sponsorees 200 profile (Name, position, department within the company) and a lead to the reasons for desiring the sponsorship 202. Similarly, a sponsor's screen 300.

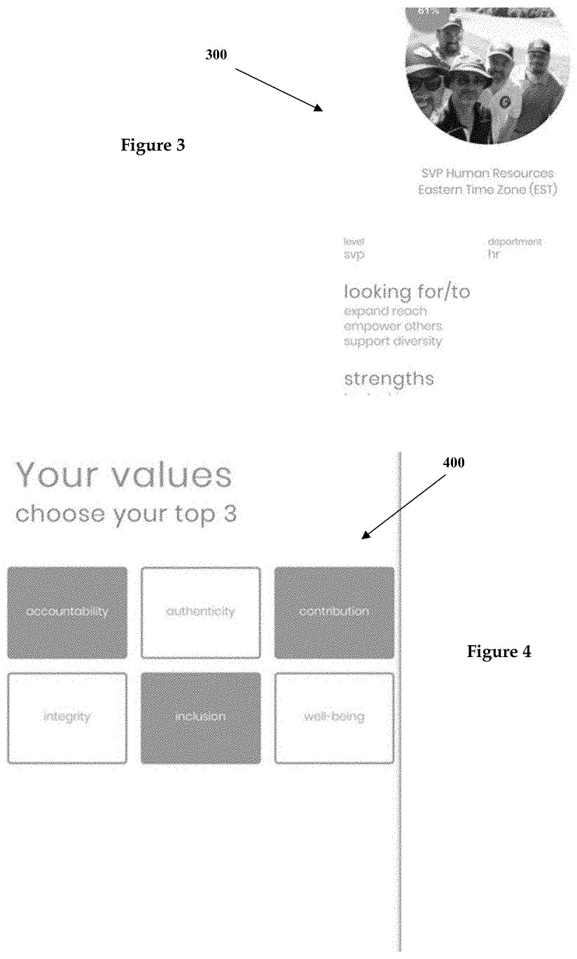

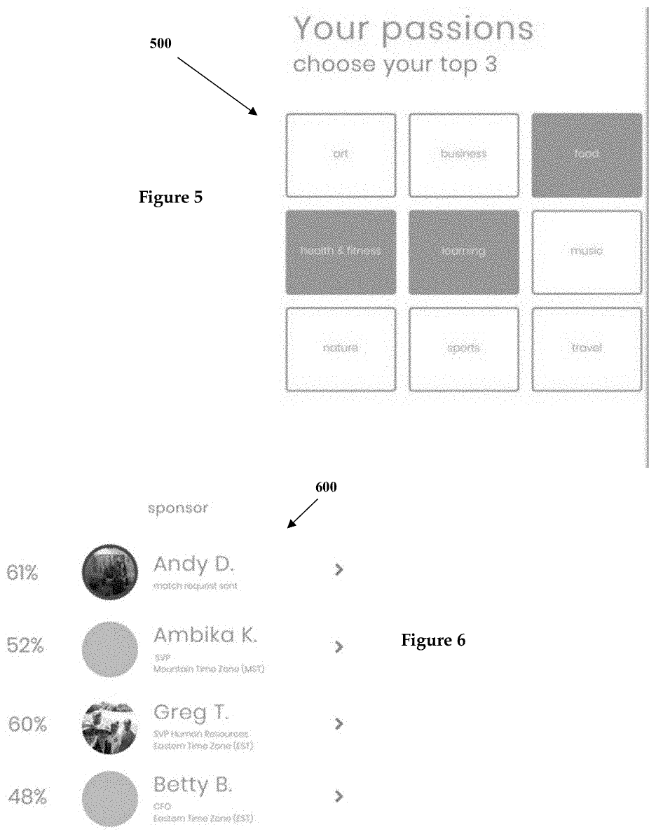

In one embodiment (FIGS. 3-5), in both cases, the sponsor 300 and sponsoree 200 will independently select their three top values 400, and their three top passions 500. Needless to say, the match may be done for less or more than three (3) selections. That means, matching is done on a user's expectations with another user's ability/skills/position.

From the responses to the selections 400/500, only the related questions are applied to the algorithm. The algorithm is applied by calculating the match for the logged in user against every other user. One set of questions may be related to values, passions, reasons to sponsor, reasons to become a sponsoree, etc.

Each question asked may have different max allowed answer. For example, a user can select a max of three options. Or, a user can just give a single answer. Matches are done based on two categories: either a Direct Match or an Indirect Match.

A Direct Match occurs if both users (i.e. Sponsor and Sponsoree) number of max answers allowed for the related questions are the same. An Indirect Match occurs when both the user's number of max answers allowed for the related question is different. From these, the algorithm performs a Calculation of the match percentage, which is performed with a simple math division. In it, Dividend=Number of matched answers for that question from both users (Sponsor and Sponsoree). The Divisor=Biggest number available between the given answers between both the users.

### Example 1

User 1 has chosen/provided 2 answers and User 2 has provided 3 answers, so the divisor would be 3. Thus the Question match of User 2 to User 1 is given as a percentage are %=(Dividend/Divisor)*100, or ⅔*100=67%.

Thus the direct match percentage for Sponsoree (DM_{E}) is calculated as:

DM_{E}=(N_{E}/D_{X})*100;

And the direct match percentage for a Sponsor (DMs) is calculated as:

DM_{S}=(N_{S}/D_{X})*100;

Where N_{S} is the number of answers chosen/provided by the Sponsor, N_{E} is the number of answers chosen/provided by the Sponsoree, D_{S} is the number of answers provided by Sponsor, D_{E} is the number of answers provided by Sponsoree and wherein Dₓ is the same as D_{S} and D_{E}.

And the indirect match percentage is calculated as;

IM_{E}=(N_{E}/D_{X})*100;

IM_{S}=(N_{S}/D_{X})*100;

for the Sponsoree (IM_{E}) or Sponsor (IM_{S}) and calculated the same as above (for either Sponsor or Sponsoree), but since and D_{S} and D_{E} are not the same, the largest is selected as D_{X}.

From the above, the Indirect Match percentage can either be 0% or 100% only. If the Dividend/Divisor value is greater than 0, the match is calculated as 100%. If the Dividend/Divisor value is 0, then any number divided by 0 is undefined and the match is calculated as 0%. Then, the Overall match percentage=Sum of all the question percentages/number of questions.

After all the match percentages (FIG. 6) against all users available are calculated, the top 5 from the final list is displayed 600 in the matches screen in the app. In the above fashion, the “Sandboxx match algorithm works on the concept of matching related answers with related questions. That means, matching is done on a user's expectations with another user's ability/skills/position. From the questionnaire that the users fill in, only the related questions are applied to the algorithm. The algorithm is applied by calculating the match for the logged in user against every other user.”

Some of the matching questions (besides asking a Sponsoree for personal information (e.g. Name)), may include the following: Position within the organization? (C-level, Vice-President, Director, etc.), Why do you want to be Sponsored? (Select 3 top of: career path, advance career, collaboration, leadership growth, expand reach, move departments, empower others, support diversity, give back, to enhance student success, provide professional socialization, provide a sense of community or participate more with the school); What do you consider your strengths? (Select 3 top of: potential, leadership, reputation, expertise, experience, commitment, seniority or availability); What do you consider your values? (Select 3 top of: accountability, authenticity, contribution, integrity, inclusion, well-being, creativity, family or achievement); What are your Passions (Select 3 top of: art, business, food, health & fitness, learning, music, nature, sports or travel); What is your ideal sponsor level [(Select 3 top of: c-level (i.e. CEO, CIO, CFO, CTO), Senior Vice Presidents (SVP), Vice Presidents (VP), Director, Manager, employee, faculty, student); What is your ideal Sponsor Dept.? (Select 3 top of: accounting and finance, admin, customer service, hr, legal, marketing, sales, technology, R&D, health, education, justice or military); What are your ideal sponsor Strengths? (Select 3 top of: potential, leadership, reputation, expertise, experience, commitment, seniority or availability); What your ideal sponsor time zone? (Select 3 top of: EST, CST, MST or PST).

### CONCLUSION

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

1. A computerized system for matching sponsors and sponsorees within an organization, said system comprising:
one or more communicatively coupled computer processors, said one or more computer processors forming a computer system configured to perform the steps of:
receiving, at said computer system, a request from a sponsor or sponsoree for inclusion in said matching system;
collecting information about said sponsor or sponsoree, including name, position, authorization code, address, email and/or telephone number;
acquiring one or more answers to a set of questions from a sponsor;
acquiring one or more answers to a set of questions from a sponsoree;
calculating the Direct Match (DM) and Indirect Match (IM) percentage of each Sponsor (DM_{S}/IM_{S}) match and for each Sponsoree (DM_{E}/IM_{E}); and
automatically connecting the top matches to each other.

2. the system of claim 1 wherein;
the direct match percentage for Sponsoree (DM_{E}) is calculated as:
DM_{E}=(N_{E}/D_{X})*100;
and the direct match percentage for Sponsor (DM_{S}) is calculated as:
DM_{S}=(N_{S}/D_{X})*100;
where N_{S} is the number of answers chosen/provided by the Sponsor, N_{E} is the number of answers chosen/provided by the Sponsoree, D_{S} is the number of answers provided by Sponsor, D_{E} is the number of answers provided by Sponsoree and wherein Dₓ is the same as D_{S} and D_{E}; and
the indirect match percentage is calculated as;
IM_{E}=(N_{E}/D_{X})*100
IM_{S}=(N_{S}/D_{X})*100
for the Sponsoree (IM_{E}) or Sponsor (IM_{S}) and calculated the same as above (for either Sponsor or Sponsoree), but since and D_{S} and D_{E} are not the same, the largest is selected as D_{X}.

3. A method for matching sponsors and sponsorees by a computer system within an organization, said method comprising:
providing one or more communicatively coupled computer processors, said one or more computer processors forming a computer system configured to perform the steps of:
receiving, at said computer system, a request from a sponsor or sponsoree for inclusion in said matching system;
collecting information about said sponsor or sponsoree, including name, position, authorization code, address, email and/or telephone number;
acquiring one or more answers to a set of questions from a sponsor;
acquiring one or more answers to a set of questions from a sponsoree;
calculating the Direct Match (DM) and Indirect Match (IM) percentage of each Sponsor (DM_{S}/IM_{S}) match and for each Sponsoree (DM_{E}/IM_{E}); and
automatically connecting the top matches to each other.

4. the method of claim 3 wherein;
the direct match percentage for Sponsoree (DM_{E}) is calculated as:
DM_{E}=(N_{E}/D_{X})*100;
and the direct match percentage for the Sponsor (DM_{S}) is calculated as:
DM_{S}=(N_{S}/D_{X})*100;
where N_{S} is the number of answers chosen/provided by the Sponsor, N_{E} is the number of answers chosen/provided by the Sponsoree, D_{S} is the number of answers provided by Sponsor, D_{E} is the number of answers provided by Sponsoree and wherein Dₓ is the same as D_{S} and D_{E}; and
the indirect match percentage is calculated as;
IM_{E}=(N_{E}/D_{X})*100
IM_{S}=(N_{S}/D_{X})*100
for the Sponsoree (IM_{E}) or Sponsor (IM_{S}) and calculated the same as above (for either Sponsor or Sponsoree), but since and D_{S} and D_{E} are not the same, the largest is selected as D_{X}.

5. A non-transitory computer-readable medium embodying a program executable in at least one computing device, the program, when executed, causing the at least one computing device to at least:
one or more communicatively coupled computer processors, said one or more computer processors forming a computer system configured to perform the steps of:
receiving, at said computer system, a request from a sponsor or sponsoree for inclusion in said matching system;
collecting information about said sponsor or sponsoree, including name, position, authorization code, address, email and/or telephone number;
acquiring one or more answers to a set of questions from a sponsor;
acquiring one or more answers to a set of questions from a sponsoree;
calculating the Direct Match (DM) and Indirect Match (IM) percentage of each Sponsor (DM_{S}/IM_{S}) match and for each Sponsoree (DM_{E}/IM_{E}); and
automatically connecting the top matches to each other.

6. the non-transitory computer-readable medium embodying a program executable in at least one computing device of claim 5 wherein;
the direct match percentage for Sponsoree (DM_{E}) is calculated as:
DM_{E}=(N_{E}/D_{X})*100;
and the direct match percentage for the Sponsor (DM_{S}) is calculated as:
DM_{S}=(N_{S}/D_{X})*100;
where N_{S} is the number of answers chosen/provided by the Sponsor, N_{E} is the number of answers chosen/provided by the Sponsoree, D_{S} is the number of answers provided by Sponsor, D_{E} is the number of answers provided by Sponsoree and wherein Dₓ is the same as D_{S} and D_{E}; and
the indirect match percentage is calculated as;
IM_{E}=(N_{E}/D_{X})*100
IM_{S}=(N_{S}/D_{X})*100
for the Sponsoree (IM_{E}) or Sponsor (IM_{S}) and calculated the same as above (for either Sponsor or Sponsoree), but since and D_{S} and D_{E} are not the same, the largest is selected as D_{X}.
